(19) United States
(12) Patent Application Publication
(10) Pub. No.: US 2006/0023890 A1
(43) Pub. Date: Feb. 2, 2006

(54) Sound field controller and method for controlling sound field

(75) Inventor: Atsunobu Kaminuma, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD.

(21) Appl. No.: 11/193,388

(22) Filed: Aug. 1, 2005

(30) Foreign Application Priority Data
Aug. 2, 2004 (JP) P2004-225536

(51) Int. Cl. H04R 5/00; H04R 5/02

(52) U.S. Cl. 381/18; 381/307; 381/61

(57) ABSTRACT

A sound field controller forms a predetermined sound field in a predetermined environment in a manner that control sounds are previously stored for each environment, the control sounds which have been designed to form a predetermined observation sound at a predetermined control point, thereafter, a control sound which corresponds to an observation sound requested to be outputted and also corresponds to a detected environment is selected from the previously stored control sounds, and subsequently, a sound output unit is allowed to output the selected control sound.

### BACKGROUND OF THE INVENTION

The present invention relates to a sound field controller and method for controlling sound field, which forms a predetermined sound field including a preset control point in a predetermined environment. More particularly, the present invention relates to a technique capable of reducing processing costs for sound field control.

Japanese Patent Laid-Open No. 2003-174699 (Patent Document 1) discloses a speech input-output device which controls a sound pressure at a predetermined control point by use of a filter (arithmetic expression) based on space transmission characteristics between the predetermined control point and a speaker. This speech input-output device generates a filter (arithmetic expression) for controlling a sound pressure at a control point based on space transmission characteristics specified by a speaker position, a seat position of a speaking person, his/her head position, temperature, humidity, a microphone position, and the like. Thus, the device performs the sound pressure control processing at the control point. According to the device described above, it is possible to control a sound pressure at a predetermined control point in accordance with an audio signal supplied for output and the space transmission characteristics.

### SUMMARY OF THE INVENTION

However, since the filter is generated to process a speech output signal generation every time speech output is executed, there has been a problem that sound field control involves enormous processing costs such as a hardware cost, a computational cost and a time cost. Moreover, there has been another problem that an enormous cost is also involved in previously storing, in a memory, filters corresponding to all the space transmission characteristics or a process of deriving each of the filters.

The present invention was made in consideration for the foregoing problems. It is an object of the present invention to provide a sound field controller capable of reducing costs for sound field control.

An aspect of the present invention provides a sound field controller that includes a memory configured to store, for each predetermined environment, control sounds designed to form a predetermined observation sound at control points having any one of at least one preset listening point and at least one aural null, an environment detection unit configured to detect an environment of a sound field including the control points, an output control unit configured to select a control sound among the control sounds stored in the memory based upon a sound output request requesting the predetermined observation sound, the selected control sound corresponding to an observation sound requested to be outputted by the sound output request and corresponding to the environment detected by the environment detection unit, and a sound output unit configured to output the selected control sound to the sound field.

Another aspect of the present invention provides a method for controlling sound field that includes storing, for each predetermined environment, control sounds designed to form a predetermined observation sound at control points having any one of at least one preset listening point and at least one aural null, detecting an environment of a sound field including the control points, selecting a control sound among the control sounds based upon a sound output request requesting the predetermined observation sound, said selected control sound corresponding to an observation sound requested to be outputted by the sound output request and corresponding to the environment detected, and outputting the selected control sound to the sound field.

A sound field controller according to the present invention forms a predetermined sound field in a predetermined environment in a manner that: control sounds are previously stored for each environment, the control sounds which have been designed to form a predetermined observation sound at a predetermined control point; thereafter, a control sound which corresponds to an observation sound requested to be outputted and also corresponds to a detected environment is selected from the previously stored control sounds; and subsequently, a sound output unit is allowed to output the selected control sound. Thus, it is possible to provide a sound field controller capable of reducing costs for sound field control.

### BRIEF DESCRIPTION OF THE DRAWINGS

FIG. 1 is a plan view of a vehicle 500 viewed from above, showing an example of a sound field formed in an interior.

FIG. 2 is a view showing a hardware configuration of a sound field controller 100 of the first embodiment.

FIG. 3 is a block diagram showing a configuration of the sound field controller 100 of this embodiment.

FIG. 4 is a view for explaining derivation processing of control sounds.

FIG. 5 is a view for explaining a control sound derivation filter which sends out a control sound.

FIG. 6 shows an example of control sounds stored in the memory 10.

FIGS. 7 and 8 show examples of the defined environment patterns.

FIG. 9 is a flowchart showing a control procedure of the first embodiment.

FIG. 10 is a block diagram showing a configuration of the sound field controller of the second embodiment.

FIG. 11 is a view for explaining the memory 10 of the second embodiment.

FIG. 12 is a flowchart showing a control procedure of the second embodiment.

FIG. 13 is a block diagram showing a configuration of the sound field controller of the third embodiment.

FIG. 14 is a view for explaining the memory 10 of the third embodiment.

FIG. 15 is a flowchart showing a control procedure of the third embodiment.

FIG. 16 is a block diagram showing a configuration of the sound field controller of the fourth embodiment.

FIG. 17 is a flowchart showing a control procedure of the fourth embodiment.

### DETAILED DESCRIPTION OF EMBODIMENTS

Various embodiments of the present invention will be described with reference to the accompanying drawings. It is to be noted that same or similar reference numerals are applied to the same or similar parts and elements throughout the drawings, and the description of the same or similar parts and elements will be omitted or simplified.

### First Embodiment

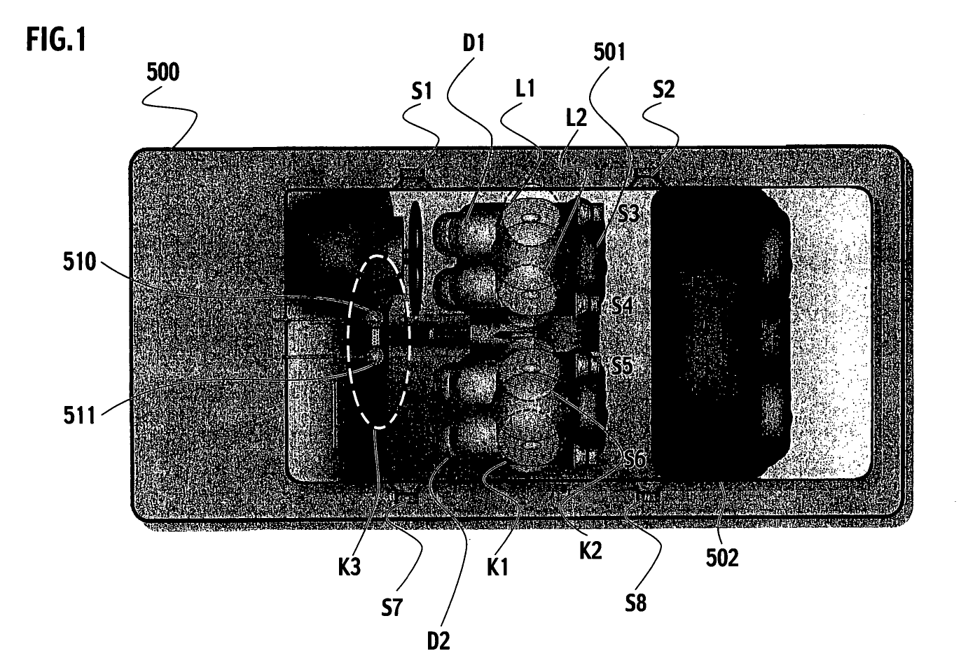

FIG. 1 is a plan view of a vehicle 500 viewed from above, showing an example of a sound field formed in an interior. A sound field controller of this embodiment forms, in a predetermined environment, a predetermined sound field which includes at least one preset listening point or at least one aural null as a control point. The sound field may include at least one listening point and at least one aural null. For purpose of illustrative convenience, the listening point, the aural null and the control point are described as “points”. However, the listening point, the aural null and the control point are not limited to “points” but may be regions, each having a certain area or volume.

The sound field controller of this embodiment is installed in a vehicle driven by a user, and it forms, in a vehicle interior in a predetermined environment, a sound field which includes one or more of control points previously set in the vehicle interior. It is assumed that, in the vehicle 500, a driver seat occupant D1 (listener 1) who sits in the driver seat represented as a front seat 501 and a passenger seat occupant D2 (listener 2) who sits in the passenger seat represented as a front seat 502 are on board. In this embodiment, listening points L1 and L2 in the vicinities of both ears of the driver seat occupant D1 are defined as control points. In addition, aural nulls K1 and K2 in the vicinities of both ears of the passenger seat occupant D2 are defined as control points. Moreover, an aural null K3 in the vicinity of a SR system 510 (Speech Recognition system) and a speech input microphone 511 including a microphone for a speech recognition device and a microphone for a hands-free telephone is defined as a control point. Furthermore, 8 speakers (S1 to S8) for outputting control sounds which form a predetermined sound field are provided on wall surfaces and the like inside the vehicle interior.

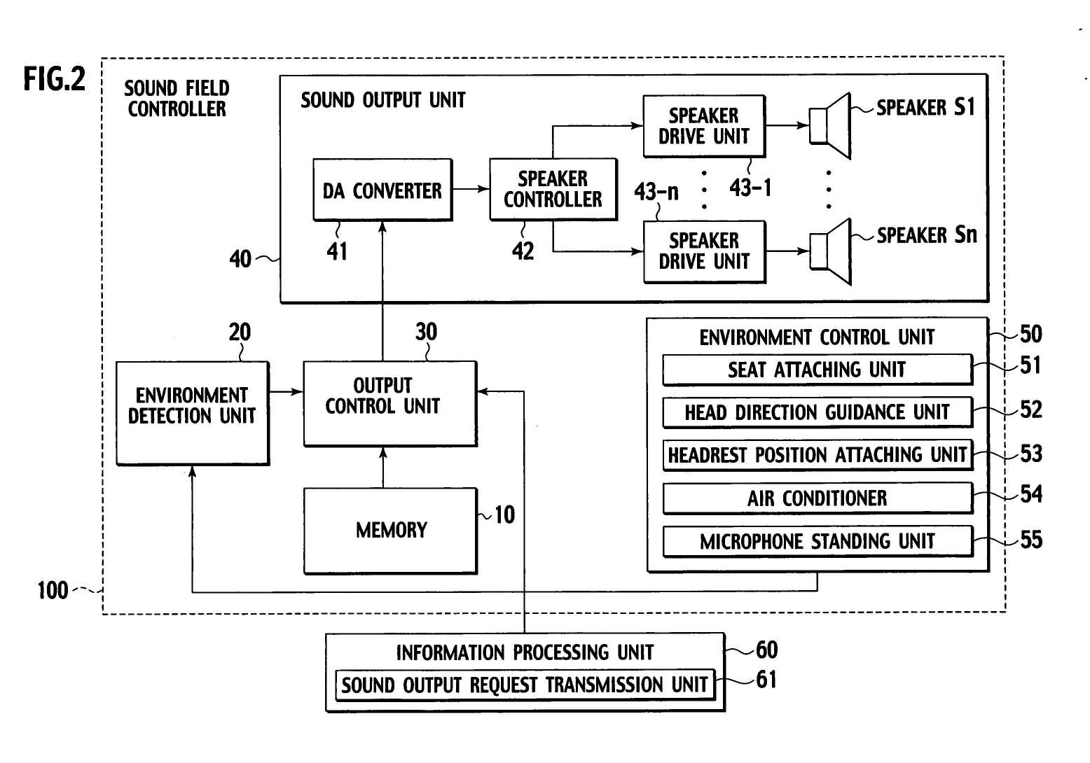

FIG. 2 is a view showing a hardware configuration of a sound field controller 100 of the first embodiment. As shown in FIG. 2, the sound field controller 100 includes a memory 10, an environment detection unit 20, an output control unit 30, a sound output unit 40, an environment control unit 50, and an information processing unit 60. The memory 10 previously stores, for each environment, control sounds which form a predetermined sound field, in other words, control sounds designed to form a predetermined observation sound at a control point set in a sound field. The environment detection unit 20 detects an environment of the sound field. The output control unit 30 outputs to the sound output unit 40 a command to output a control sound corresponding to a detected environment. The sound output unit 40 includes a DA converter 41, a speaker controller 42, a plurality of speakers S1 to Sn, and drive units (43-1 to 43-n) for driving the respective speakers, and outputs control sounds which form a sound field. The environment control unit 50 controls variations in environmental factors so as to keep the environment of the sound field unchanged until the control sound corresponding to the detected environment is outputted.

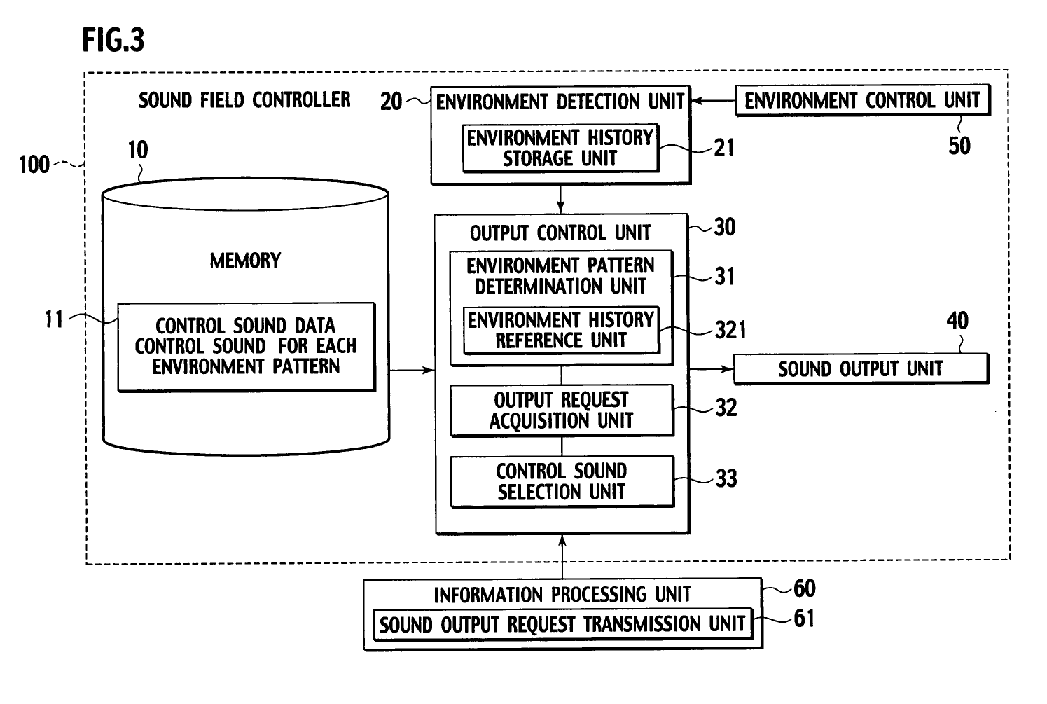

FIG. 3 is a block diagram showing a configuration of the sound field controller 100 of this embodiment. As shown in FIG. 3, the sound field controller 100 includes the memory 10, the environment detection unit 20, the output control unit 30, the sound output unit 40, and the environment control unit 50. The sound field controller 100 described above can be realized by including at least: a ROM storing a program for selecting and outputting a control sound which corresponds to an environment sound requested to be outputted and also corresponds to a detected environment; a CPU which implements the output control unit 30 by executing the program stored in the ROM; and a RAM which functions as the accessible memory 10.

The memory 10 stores control sound data 11 so as to correspond to environments, the control sound data 11 which have been outputted by the sound output unit 40 and have been designed so as to form a predetermined observation sound at a predetermined control point in a predetermined environment. The control points include one or more of preset listening points and/or aural nulls. By use of the control sound which forms the predetermined observation sound at the predetermined control point, a predetermined sound field can be formed in the predetermined environment. Here, the “predetermined environment” in which the sound field is formed means a “predetermined state” where each of one or more of environmental factors of the sound field, which affect sound transmission characteristics, is within a predetermined range.

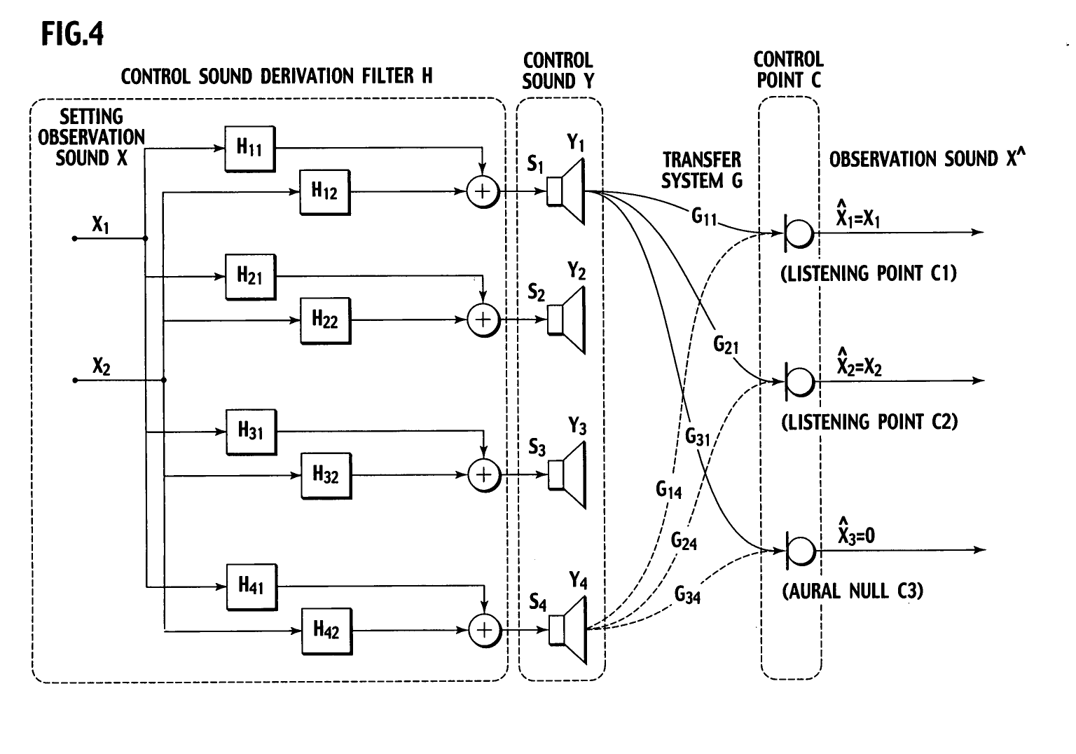

The control sounds stored in the memory 10 will be described with reference to FIGS. 4 to 7. FIG. 4 is a view for explaining derivation processing of control sounds. X1 and X2 shown on an input side in FIG. 4 are setting observation sounds listened by a listener in the predetermined sound field. The setting observation sounds include both of preset known sounds and unknown sounds which differ depending on situations. Here, the preset known sounds include an alarm sound and a guidance sound, and the unknown sounds include a sound received from broadcasting such as a radio, a reading voice to read e-mail or provided information which are available through the Internet, a route guiding voice obtained from an in-vehicle navigation system, and a speaking voice obtained through a mobile communication network. In the first embodiment, the known sounds such as the alarm sound, an alarm speech, the guidance sound and a guidance speech are defined as the setting observation sounds.

Meanwhile, Xˆ1 to Xˆ3 shown on an output side are actual observation sounds which are actually observed by the listener. The actual observation sound Xˆ is a sound which is generated from a control sound group Y outputted by the speakers S1 to S4 after it is transmitted through a sound field transmission system G11 to G34 and is actually heard by the listener. In this embodiment, C1 and C2 are listening points (control points). At the listening point C1, the listener actually listens to the actual observation sound Xˆ1 (Xˆ1 is nearly equal to X1) which is approximately the same as the set setting observation sound X1. Similarly, at the listening point C2, the listener actually listens to the actual observation sound Xˆ2 (Xˆ2 is nearly equal to X2) which is approximately the same as the set setting observation sound X2. C3 is an aural null, and the listener observes no sound at the aural null C3 (Xˆ3 is nearly equal to 0). Although not particularly limited, it is preferable that the listening points C1 and C2 are at positions corresponding to positions of both ears of the listener. To be more specific, it is preferable that C1 and C2 are set at positions corresponding to listening points L1 and L2 for the listener D1 shown in FIG. 1. Moreover, it is preferable that the aural null C3 is at a position in the vicinity of a microphone provided in the vehicle. To be more specific, it is preferable that C3 is set at a position corresponding to the aural null K3 shown in FIG. 1. It is preferable that the positions of the control points including the listening points and the aural null are specified based on space coordinate axes of the sound field. In this embodiment, the positions of the control points, in other words, positions in the vicinities of the ears of the listener, positions of the speakers, positions of microphones and the like are defined based on three-dimensional coordinate axes set in a closed space formed in the vehicle interior of the vehicle 500.

H11 to H42 shown in FIG. 4 are control sound derivation filters which control the known setting observation sounds to be observed at the respective control points (C1 to C3). The control sound derivation filters H11 to H42 are designed to approximate the actual observation sound Xˆ, which is actually observed by transmitting transmission characteristics through a space that is G11 to G34, to the setting observation sound X that is an input signal. In this embodiment, control is performed so that the known setting observation sounds are heard by the listener at the listening points C1 and C2. At the same time, control is performed so that no sound is heard by the listener at the aural null C3. Ideally, Xˆ1=X1, Xˆ2=X2 and Xˆ3=0 should be established. Specifically, at the listening points C1 and C2, the control sound derivation filters H11 to H42 are designed to cancel the sound transmission characteristics G11 to G34. There exist 12 routes of the transmission system for the three control points from the four speakers. Meanwhile, there exist only 8 control sound derivation filters H. This is because, in order to set Y3=0 at the aural null C3, the control sound derivation filters (H13 to H43) for the transmission system G31 to G34 are not necessary.

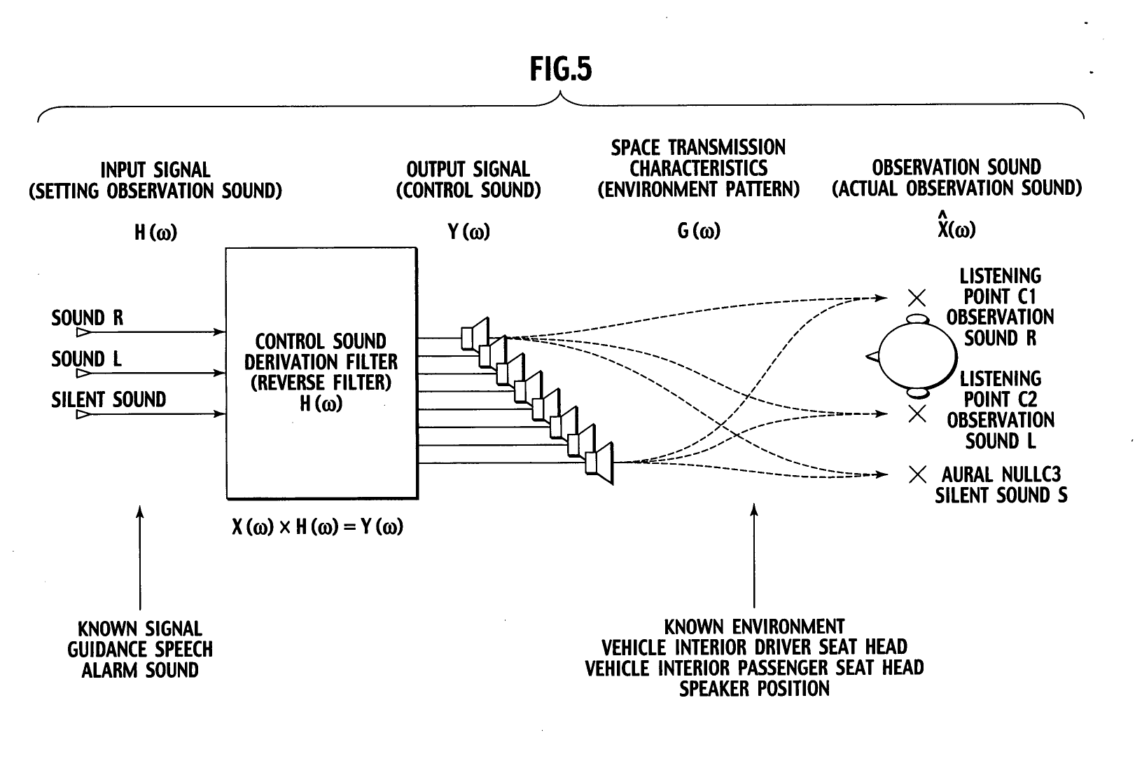

FIG. 5 is a view for explaining a control sound derivation filter which sends out a control sound. As shown in FIG. 5, a setting listening sound expected to be heard by the listener is set as an input signal X(,,). A control sound outputted by the speaker of the sound output unit 40 is set as an output signal Y(,,). A control sound derivation filter which derives the output signal Y(,,) based on the input signal X(,,) is set as H(,,). The outputted control sound Y(,,) is observed by the listener as an observation sound R, an observation sound L and an aural null S at the control points C1 to C3 through an interior transmission system G(,,) in the vehicle interior.

A sound field control system of the sound field controller 100, which is shown in FIG. 5, can be described as below. The input signal (setting observation sound) X(,,), the actual observation sound X(,,) which is actually observed, the output signal (control sound) Y(,,), the control sound derivation filter H(,,), and a space transmission characteristic G(,,) in this embodiment are all described in frequency equations.
X(,,)H(,,)G(,,)=Xˆ(,,) (1)

The output signal (control sound) Y ((1)) is described as below.
Y(,,)=X(,,)H(,,) (2)

In order to approximate the actual observation sound Xˆ(,,), which is actually observed, to the setting observation sound X(,,), which is expected to be heard, a relation between the control sound derivation filter and the space transmission characteristic G(,,) is as follows.
X(ω))≈\hat{X}(ω) [symbol] H(ω)G(ω)=I (3)

From the above, the control sound derivation filter H(,,) can be obtained as below. Here, G(,,)⁻is a generalized inverse matrix. Note that, as to the aural null, H(,,) is designed so as to set the actual observation sound Xˆ(,,) to 0.
H(,,)=G(,,)⁻ (4)

The input signal (setting observation sound) X(,,), the actual observation sound X⁻(,,) which is actually observed, the output signal (control sound) Y(,,), the control sound derivation filter H(,,), and the space transmission characteristic G(,,) in this embodiment are all described in frequency expressions.

Note that designing of the control sound derivation filter H(,,) is described in Patent Document 1 and “Application to Trans-aural System of Reverse Filter Design Using Least Norm Solution” by Atsunobu Kaminuma et al.: Acoustical Society of Japan, Lecture Collection, pp 495 to 496 (1998). The control sound derivation filter H(,,) which derives the control sound differs by environment pattern. Thus, it is preferable that the control sound derivation filter H(,,) is obtained based on an observation sound and a control sound which are measured for each environment pattern.

In this embodiment, the setting observation sound X(,,) expected to be heard is previously set. Moreover, those factors that affect the space transmission characteristic G(,,), such as an environment of a sound field, in other words, a space of the sound field, positions of control points, a position of a listener, and temperature and humidity of the sound field, are previously set. Furthermore, in this embodiment, the environment of the sound field in the vehicle interior is previously defined, and the space transmission system G(,,) corresponding thereto is previously obtained. Accordingly, the control filters H(,,) are defined, respectively, based on the space transmission system G(,,) in the obtained predetermined environment.

In this embodiment, by defining one or more of environment patterns, the space transmission characteristic G(,,) can be previously obtained. There are an infinite variety of environment patterns of the sound field formed by interactions of environmental factors. In this embodiment, however, as to a sound field formed in a predetermined space such as a vehicle interior, seats in a concert hall, a movie theater, a library or a home audio system, environmental factors such as relative positions of listeners and temperature and humidity of the space are previously defined. Accordingly, environment patterns of the sound field are defined to be finite. By previously defining finite environment patterns, control filters H(,,) corresponding to the respective environment patterns can be set to be finite. Moreover, in this embodiment, setting observation sounds to be outputted are previously defined. Thus, the control sounds Y(,,) corresponding to the setting observation sounds X(,,) can be previously obtained by use of the finite control filters H(,,). In this embodiment, an environment of a sound field is previously defined, and a control sound Y which forms a predetermined observation sound X at a control point included in the sound field is stored for each environment pattern, in a control sound data storage region 1 1 of the memory 10.

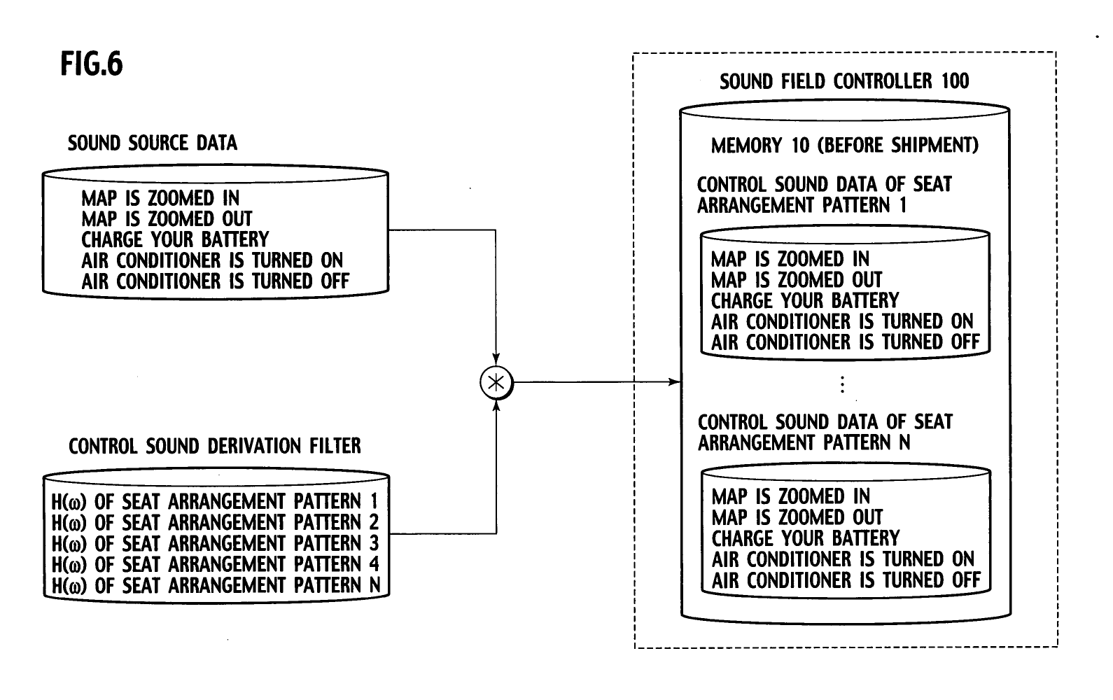

FIG. 6 shows an example of control sounds stored in the memory 10. In this embodiment, environment patterns are defined based on positions at which seats are arranged. The memory 10 of the sound field controller 100 stores control sound data corresponding to seat arrangement patterns 1 to n for each of the seat arrangement patterns (environment patterns).

The seat arrangement pattern of this embodiment is defined as follows, in the case where seat positions are found as being shifted in stages in a manner that each of them is shifted away from a steering wheel by a multiple of a predetermined width. A first-stage seat position which is closest to the steering wheel is defined as a seat arrangement pattern 1. In addition, a second-stage position which is shifted by one stage away from the steering wheel is defined as a seat arrangement pattern 2. Moreover, an nth-stage position which is shifted by n stages away from the steering wheel is defined as a seat arrangement pattern (environment pattern) n. In this embodiment, the seat arrangement pattern is an environment pattern which defines the environment of the sound field.

Moreover, in this embodiment, sound source data of the observation sounds X(,,) expected to be heard by the listener are previously prepared. The sound source data include guidance speeches, alarm sounds and the like. Although not particularly limited, FIG. 6 shows an example of the sound source data used in this embodiment. The sound source data of this embodiment include a guidance speech such as “map is zoomed in”, an alarm speech such as “charge your battery” and the like. Moreover, in this embodiment, control sound derivation filters corresponding to the environment pattern (seat positions in the vehicle interior) of the sound field are previously prepared. By use of the control sound derivation filters, control sound data corresponding to the environment pattern (the seat positions) of the sound field are previously created based on the previously prepared sound source data (observation sounds) and are previously stored in the memory 10 before shipment. The control sound data are associated with the environment pattern (seat position pattern) of the sound field and are stored so as to be searchable by use of the environment pattern of the sound field as a key.

In the example shown in FIG. 6, for convenience, the environment pattern of the sound field is defined mainly based on the seat positions. However, the environment pattern of the sound field can be defined based on the following environmental factors or combinations thereof: a size of a sound field space (vehicle interior), the number and arrangement of speakers, the number of vehicle occupants, positions of the respective occupants, seat positions of the respective occupants, seat angles of the respective occupants, positions of backrests (reclining) of the respective occupants, positions of headrests of the respective occupants, positions of control points, temperature of the sound field, humidity of the sound field, and the like. In the case where the sound field is formed in the vehicle interior, the environmental factors include: static environmental factors such as the size of the vehicle interior and the number and arrangement of speakers; and dynamic environmental factors which are changed depending on body shapes of the vehicle occupants, such as the seat positions, the positions of the backrests and the positions of the headrests. In this embodiment, the kinds of the environmental factors described above and a set value range of the environmental factors are arbitrarily set. Thus, the environment pattern is defined.

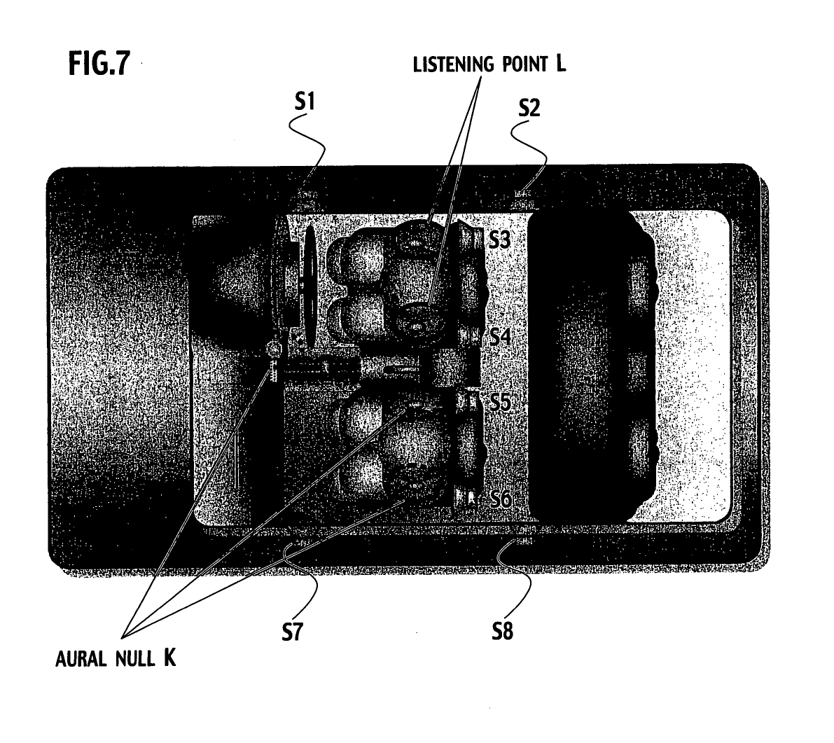

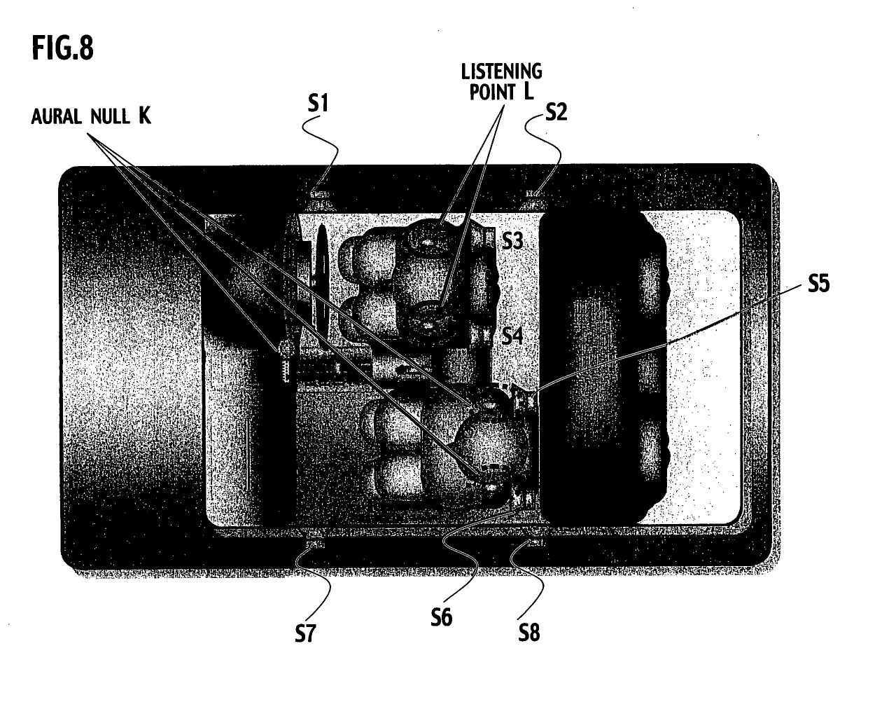

FIGS. 7 and 8 show examples of the defined environment patterns. FIGS. 7 and 8 are schematic views of the vehicle interior viewed from above, showing the examples of the defined environment patterns. An environment pattern 1 shown in FIG. 7 and an environment pattern 2 shown in FIG. 8 have common static environmental factors such as the size of the vehicle interior (sound field space) and the number and arrangement of speakers, but are different from each other in dynamic environmental factors such as the seat positions and the positions of the backrests. To be more specific, compared to the environment pattern 1, the environment pattern 2 is different in that a position of the passenger seat is shifted backward and a backrest thereof is reclined. Since the seat positions and the angles of the backrests are different from each other, positions of listening points L and aural nulls K become different. Accordingly, the environment of the sound field becomes different. Thus, these environments are defined as environment patterns different from each other.

Although not particularly limited, it is preferable that the memory 10 is a rewritable storage medium such as a HDD or a RAM. Thus, if a vocabulary expected to be heard is changed, the vocabulary can be updated to a new vocabulary. Thus, the memory can be updated so as to store only control sounds corresponding to an environment unique to vehicle occupants.

The environment detection unit 20 detects an environment of a sound field including control points. It is preferable that the environment detection unit 20 detects at least a position of a listener, a direction of the listener's head, a position of the listener's seat, a position of a headrest that the listener uses, temperature of the sound field, humidity of the sound field, and positions of microphones for a speech recognition device and a hands-free telephone. The reason is that since the environmental factors described above are considered to have high degrees of contribution to an environment of the sound field, an environment pattern determined by use of the environmental factors described above is considered to meet the actual environment. By outputting control sounds corresponding to an environment pattern determined based on the environmental factors described above, it is possible to allow the listener to observe target observation sounds at predetermined control points.

To be more specific, the environment detection unit 20 detects the number of vehicle occupants to be listeners and in which seat position (a driver seat, a passenger seat or a rear seat) each of the listeners is found. For the detection, a pressure sensor or an infrared sensor may be used or, it may be detected whether or not each of the seat belts is worn. The environment detection unit 20 detects in which direction each listener's head is facing. A CCD camera or the like can be used for the detection. The environment detection unit 20 detects the seat positions of the listeners and set positions of the headrests that the listeners use. The environment detection unit 20 detects the temperature and humidity of the vehicle interior by use of a temperature sensor and a humidity sensor. The environment detection unit 20 detects positions of microphones. It is preferable that the positions of the microphones are previously fixed. It is preferable that the environment of the sound field thus detected is stored as an environment detection history in a predetermined memory.

After the environment detection unit 20 detects the environment of the sound field and sends out the detection result to the output control unit 30, the environment control unit 50 controls variations in environmental factors forming the environment so as to keep the environment unchanged until control sounds corresponding to the detected environment are outputted by the sound output unit 40. As shown in FIG. 2, the environment control unit 50 of this embodiment specifically includes at least any one of: a seat fixation unit 51 which fixes front and back positions of respective seats of the listeners D1 and D2 by using a gripping member to grab a seat rail for sliding the seats; a head direction guidance unit 52 which fixes directions of heads of the listeners D1 and D2 by guiding the directions thereof into predetermined directions; a headrest position fixation unit 53 which fixes positions of headrests which support the heads of the listeners D1 and D2 (see FIG. 1); an air conditioner 54 which maintains constant temperature and/or humidity of the sound field (vehicle interior in this embodiment); and a microphone supporting unit 55 which fixes positions (positions relative to the listeners) of microphones for a speech recognition device or a hands-free telephone, the positions which can be control points. The head direction guidance unit 52 of this embodiment generates a guidance sound from the vicinity of the microphone and guides the direction of the listener's head toward the microphone. If the position of the listener is changed before output of control sounds corresponding to the detected environment is completed after detection of the environment, it results in that actual observation sounds actually heard by the listener differ from setting observation sounds expected to be heard. As in the case of this embodiment, by providing the environment control unit 50, it is possible to prevent a variation in the environment between detection of the environment and output of control sounds. Thus, target sound field control can be surely executed. Specifically, it is possible to surely form a sound field in which the listener can listen to predetermined observation sounds at predetermined control points. Particularly, the target sound field control can be surely executed by preventing variations in the listener's position, the direction of the listener's head, the temperature and/or humidity of the sound field, and the position and direction of the microphone.

The sound output unit 40 outputs control sounds which form, in a predetermined environment, a predetermined sound field including one or more of preset listening points and/or aural nulls as control points. In this embodiment, a plurality of speakers are disposed as the sound output unit 40 in the vehicle interior which is the sound field. The respective speakers output control sounds different from each other, and form observation sounds, each of which has a predetermined sound pressure, phase and frequency, for predetermined control sounds.

As shown in FIG. 3, the output control unit 30 includes an environment pattern determination unit 31, an output request acquisition unit 32 and a control sound selection unit 33, and outputs predetermined control sounds to the sound output unit 40.

The environment pattern determination unit 31 determines an environment pattern of a sound field to be controlled based on environment information detected by the environment detection unit 20. The environment pattern determination unit 31 compares the detected environment information with environment information on previously defined environment patterns, and determines an environment pattern approximate to (having a highly similarity with) an actually detected environment. The determination of the environment pattern may be performed based on one environmental factor or based on a plurality of environmental factors. If the environment pattern is determined based on the plurality of environmental factors, it is preferable that a suitable environment pattern is determined in the following manner. Weighting of the respective environmental factors is performed, and degrees of approximation to environmental factors of the previously defined environment patterns are obtained. Thus, the suitable environment pattern is determined based on the weighting and the degrees of approximation. In this embodiment, the most approximate environment pattern is determined based on a plurality of pieces of information to be the environmental factors. However, the environment pattern may be determined based on one piece of information (for example, the seat position or the like) among the environmental factors.

The environment pattern determination unit 31 of this embodiment includes an environment history reference unit 321. If the environment history reference unit 321 is used, the environment pattern determination unit 31 extracts a frequently-detected environment pattern by referring to an environment history detected and stored by the environment detection unit 20, and determines the extracted environment pattern to be an environment suitable for the environment of the sound field to be controlled. The positions of the listeners, the seat positions of the listeners, the positions of headrests used by the listeners, the temperature of the sound field, the humidity of the sound field, the positions of microphones and the like are determined according to users. For example, if a car is constantly occupied by the same users as usually seen in the case of a private car, a position of a driver seat, an angle of a backrest, a position of a headrest, settings of an automatic air conditioner (settings of temperature and humidity), and the like can be expected to be substantially the same for each user. In such a case, if the frequently-detected environment is determined to be the environment pattern of the sound field to be controlled, determination involving detection errors can be avoided. Thus, accurate sound field control can be performed.

The output request acquisition unit 32 acquires a sound output request for predetermined observation sounds from the external information processing unit 60. The external information processing unit 60 is an in-vehicle navigation system, information provision equipment, an e-mail system, a speech recognition device or the like, which outputs an announcement speech, an alarm speech and a guidance speech during its operations. The information processing unit 60 has a sound output request sending-out unit 61, and thereby sends out a sound output request signal to the output control unit 30 of the sound field controller 100 when an announcement and the like are required during its operations. For example, upon receipt of a command to enlarge presented map information from a user, the information processing unit 60 sends out, to the output request acquisition unit 32, a sound output request for a guidance speech “map is zoomed in”.

When the output request acquisition unit 32 acquires the sound output request, the control sound selection unit 33 selects, from the control sounds stored in the memory 10, a control sound which corresponds to an observation sound requested to be outputted and also corresponds to the environment pattern determined by the environment pattern determination unit 31. Thereafter, the control sound selection unit 33 allows the sound output unit 40 formed of one speaker or more to output the selected control sound.

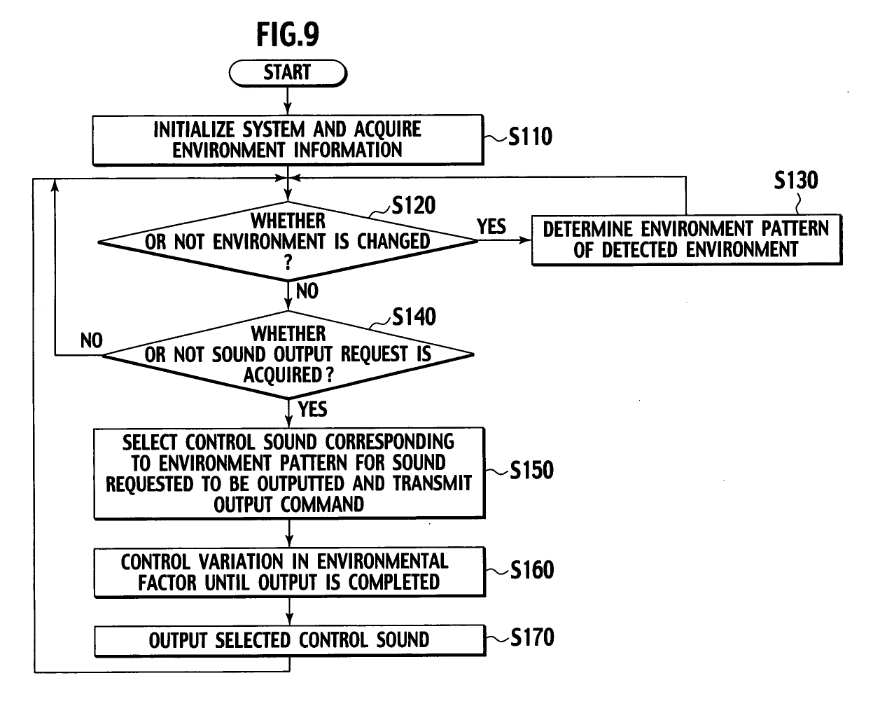

FIG. 9 is a flowchart showing a control procedure of the first embodiment. The control procedure of the sound field controller 100 will be described with reference to the flowchart of FIG. 9. When the sound field controller 100 is started, a system is initialized, and the environment detection unit 20 acquires environment information (S110). Environmental factors of environment information to be acquired are previously determined. The environment detection unit 20 acquires the environment information at predetermined timing, and transmits the acquired information to the output control unit 30. The environment pattern determination unit 31 of the output control unit 30 determines whether or not the environment information acquired by the environment detection unit 20 is changed (S120), and, if there is a change in the environment (Y in S120), determines an environment pattern of the detected environment (S130). The environment pattern determination unit 31 determines the change in the environment at predetermined timing, and continues determination of the environment pattern at the current moment until a sound output request is made (N in S140). The environment pattern determination unit 31 may determine the environment pattern based on the current environment detected by the environment detection unit 20 or may determine the environment pattern based on an environment history stored in an environment history storage unit 21 of the environment detection unit 20.

In the above case, it is preferable that a frequently-detected environment is determined to be the environment pattern based on a detected frequency. The environment history storage unit 21 of the environment detection unit 20 stores a history of determination processing of the environment pattern.

When the output request acquisition unit 32 acquires the sound output request (Y in S140), a control sound which corresponds to an observation sound (an alarm speech or the like) requested to be outputted and corresponds to the pattern determined by the environment pattern determination unit 31 is selected from control sound data in the memory 10, and thereafter, a command to output the control sound is sent out to the sound output unit 40 (S150). Until after output of the control sound is completed, the environment control unit 50 controls variations in environmental factors. In this embodiment, seat positions of listeners (vehicle occupants) are fixed so as not to be changed (S160). The sound output unit 40 outputs the control sound in accordance with a control command from the output control unit 30 (S170).

According to the sound field controller 100 of this embodiment, which is configured and operated as described above, in cases where an environment pattern of a sound field in which a listener hears an observation sound can be defined, a control sound generated based on a defined environment pattern and an observation sound expected to be outputted is previously stored in association with an environment. Thus, processing costs required when the control sound is outputted can be reduced. Specifically, according to this embodiment, processing costs such as hardware costs, computational costs and time costs can be reduced. For example, in the case where a multi-channel audio system is operated, it is not required to use a high-speed processing device such as a DSP (digital signal processor). Thus, according to this embodiment, by previously defining the environment pattern of the sound field, sound field control can be realized, which has been difficult to be realized due to enormous processing costs.

Particularly, as to an alarm speech and a guidance speech which are preferably outputted without any time lag after they are requested to be outputted, control sounds can be outputted in real time. Thus, it is possible to realize sound field control which gives no sense of discomfort to a user.

### Second Embodiment

Next, a sound field controller 200 of a second embodiment will be described. The sound field controller 200 of the second embodiment allows a memory 10 to previously store predetermined control sounds and sequentially generates control sounds which are not previously stored.

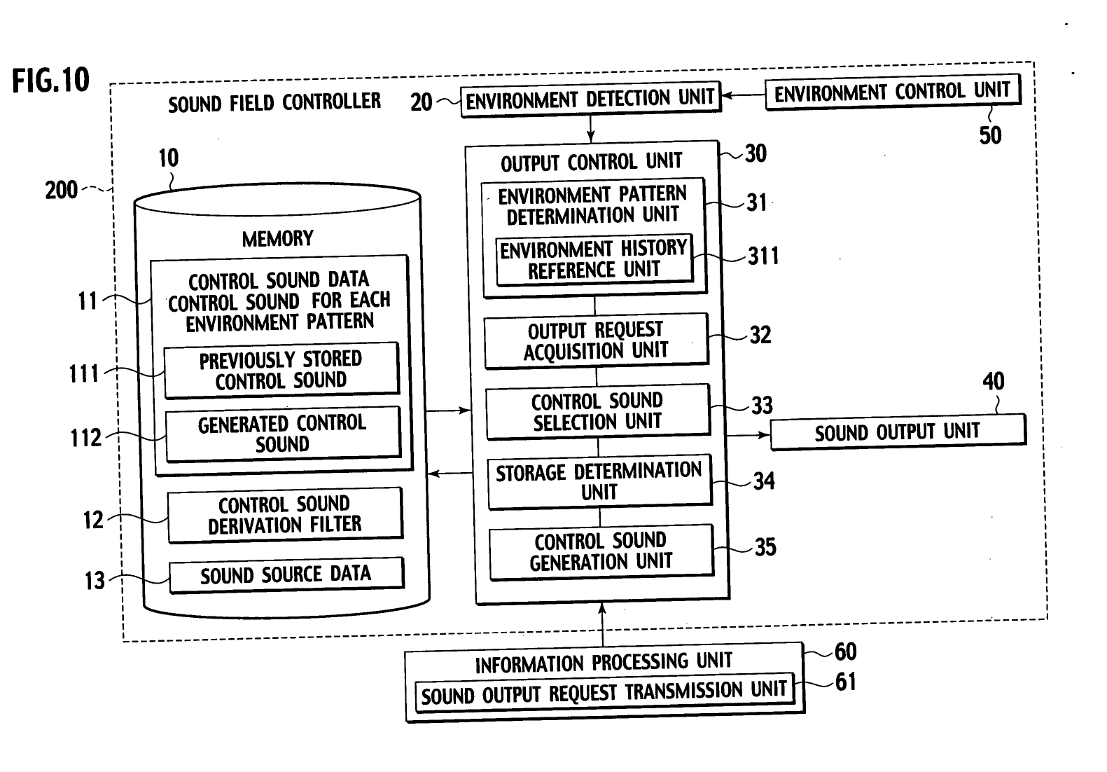

FIG. 10 is a block diagram showing a configuration of the sound field controller of the second embodiment. As shown in FIG. 10, the sound field controller 200 of this embodiment includes the memory 10, an environment detection unit 20, an output control unit 30, a sound output unit 40, and an environment control unit 50. The configuration and operations are basically the same as those of the sound field controller 100 of the first embodiment. Here, differences between the first and second embodiments will be mainly described, and repetitive description of the common parts will be omitted.

The memory 10 of this embodiment includes control sound data 11 stored for each environment pattern, a control sound derivation filter 12, and sound source data 13 which are setting observation sounds. The control sound data 11 are sound data designed to form a predetermined observation sound at a predetermined control point when they are outputted by the sound output unit 40, and are stored in association with the environment patterns. The previously stored control sound data 11 include control sounds corresponding to static observation sounds such as a guidance speech, an alarm speech, a guidance sound and an alarm sound. The control sound derivation filter 12 is a filter which derives, based on the detected environment, a control sound which forms a predetermined observation sound at a predetermined control point. The control sound derivation filter 12 corresponds to the control sound derivation filter H(,,) which was described in the first embodiment with reference to FIGS. 4 and 5. The control sound derivation filter 12 is stored in associated with an environment (environment pattern). The control sound derivation filter 12 of this embodiment is a filter not for deriving static observation sounds such as an alarm sound but for deriving unknown observation sounds such as a speech from a radio, a reading voice to read e-mail and the like, a voice conversation over the telephone, and a voice mail speech. Moreover, it is preferable that the control sound derivation filter 12 of this embodiment is set to be a filter corresponding to an environment other than environments previously set in derivation of the control sound data stored in the memory 10. A control sound in a normal environment is selected from the previously stored control sounds, and only a control sound in a special environment is generated in real time. Thus, processing costs for sound field control can be reduced as much as possible.

The sound source data 13 are setting observation sounds expected to be heard by a listener. In the case where a control sound for a static guidance speech is generated in a special environment, the sound source data 13 are used as input signals (X in FIGS. 4 and 5).

The output control unit 30 of this embodiment includes a storage determination unit 34 and a control sound generation unit 35, besides an environment pattern determination unit 31, an output request acquisition unit 32 and a control sound selection unit 33. The storage determination unit 34 and the control sound generation unit 35 which are features of the second embodiment will be described.

When the output request acquisition unit 32 acquires an output request, the storage determination unit 34 determines whether or not a control sound, which corresponds to an observation sound requested to be outputted and also corresponds to an environment pattern determined based on a detected environment by the environment pattern determination unit 31, is stored in the control sound data 11 of the memory 10. If the control sound corresponding to the environment pattern requested to be outputted is stored in the control sound data 11, the storage determination unit 34 sends out the result to the control sound selection unit 33. Upon receiving the determination result from the storage determination unit 34, the control sound selection unit 33 selects a target control sound from the control sound data 11 and allows the sound output unit 40 to output the selected control sound.

Meanwhile, if the control sound corresponding to the environment pattern requested to be outputted is not stored in the control sound data 11, the storage determination unit 34 sends out the result to the control sound generation unit 35. The control sound generation unit 35 derives the control sound corresponding the observation sound requested to be outputted by use of a control sound derivation filter corresponding to the environment pattern determined based on the detected environment by the environment pattern determination unit 31. Thereafter, the control sound generation unit 35 allows the sound output unit 40 to output the derived control sound.

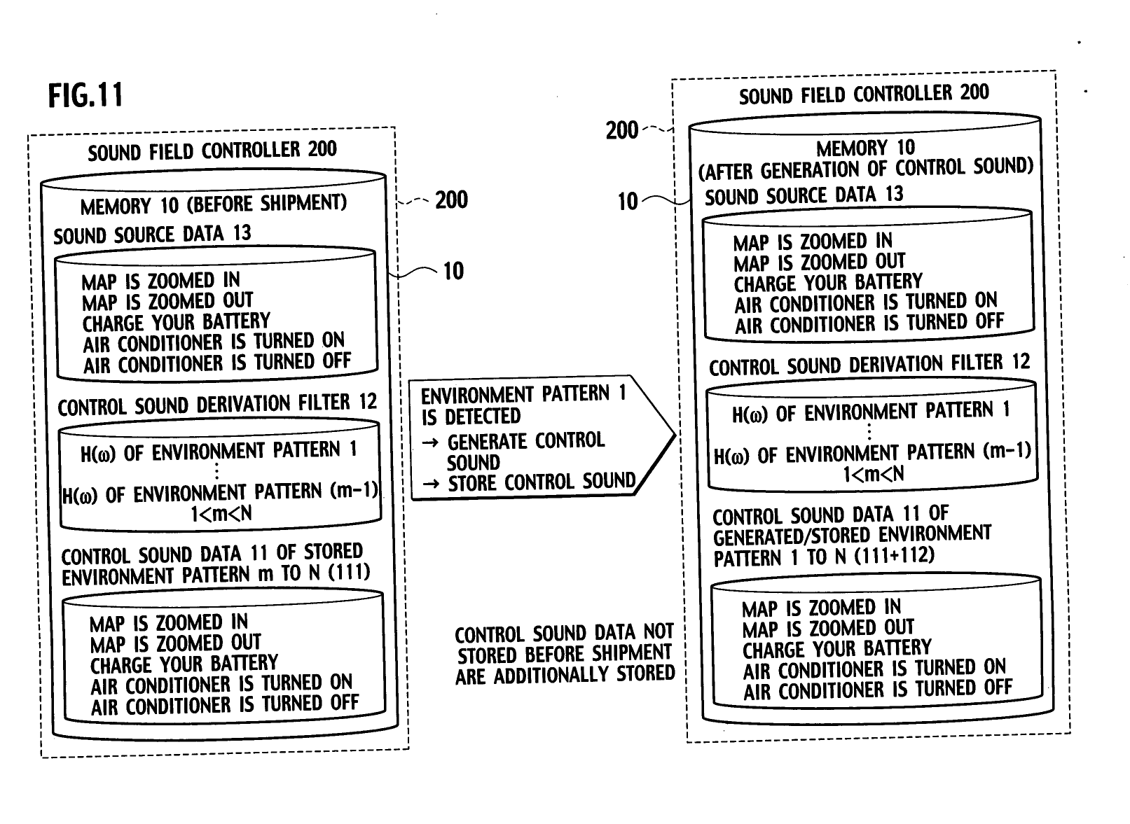

FIG. 11 is a view for explaining the memory 10 of the second embodiment. As shown in FIG. 11, the memory 10 at the time of shipment (before shipment) stores the sound source data (setting observation sounds) 13, the control sound derivation filter 12, and the previously stored control sound data 11. The previously stored control sound derivation filter 12 corresponds to environment patterns 1 to (m-1). Meanwhile, the control sound data 11 correspond to environment patterns m to N. Here, the environment patterns correspond to 1<m<N. The environment patterns of the previously stored control sounds are different from the environment patterns of the control sound derivation filter for generating the control sounds, and the both kinds of patterns are in a complementary relationship.

The memory 10 of the sound field controller 200 shown on the right side of FIG. 11 is the memory 10 after a user has started to use the memory. After use of the memory is started, the environment patterns 1 to (m-1) having no control sounds previously stored are detected. Thereafter, control sound data 1 to (m-1) are generated by use of the control sound derivation filter 12 of the environment patterns 1 to (m-1) and are stored in the memory 10. Accordingly, in the control sound data 11 after use of the memory is started, newly generated control sounds 112 (1 to (m-1)) are added to previously stored control sounds 111 (m to N), and control sounds corresponding to the environment patterns 1 to N are stored.

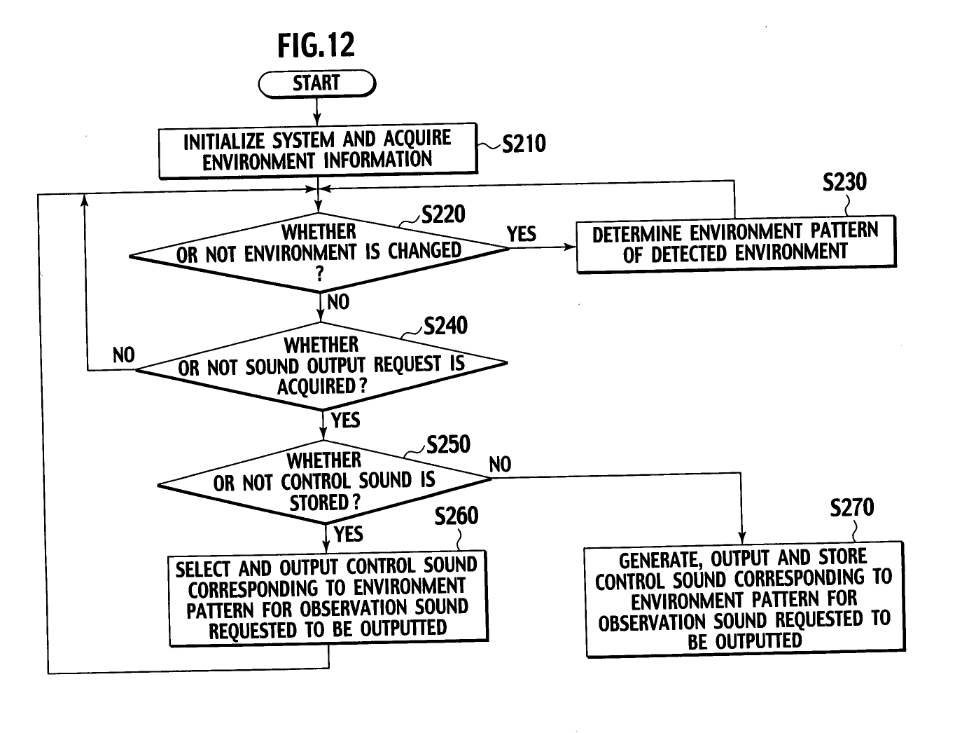

FIG. 12 is a flowchart showing a control procedure of the second embodiment. An operation procedure of this embodiment will be described with reference to FIG. 12. Steps S210 to S240 in FIG. 12 are the same as Steps S110 to S140 described with reference to FIG. 9. When the output request acquisition unit 32 acquires a request to output an observation sound in S240, the storage determination unit 34 determines whether or not a target control sound is stored in the control sounds 111 of the memory 10, the target control sound which corresponds to the requested observation sound and also to the environment pattern determined based on the detected environment (S250). If the storage determination unit 34 determines that the target control sound is stored (Y in S250), a control sound corresponding to the environment pattern is selected from the previously stored control sounds 111 or the generated control sounds 112 for the observation sound requested to be outputted. Thereafter, the sound output unit 40 is allowed to output the selected control sound (S260). Meanwhile, if the storage determination unit 34 determines that the target control sound is not stored (N in S250), the control sound generation unit 35 generates a control sound corresponding to the environment pattern for the observation sound requested to be outputted, and allows the sound output unit 40 to output the generated control sound (S270). Furthermore, the control sound generation unit 35 additionally stores the generated control sound in the control sound data 112 of the memory 10 (S270). The stored control sound data 112 is managed together with the previously stored control sound data 111. Thus, the control sound data 111 and 112 together can be set as a database through which the control sound selection unit 34 makes a selection.

According to this embodiment, sound field control can be executed in any of such cases where output of an observation sound is requested in an environment which is not previously set as an environment pattern, and where output of a dynamic observation sound such as a voice reading an e-mail is requested. Thus, it is possible to avoid a situation where the sound field control is disabled by a response failure. In such cases where output of a static observation sound such as an alarm sound is requested, or where output of a static observation sound is requested in an environment set as a normal environment pattern, a control sound is selected from the previously stored control sound data 11. Therefore, a control sound is generated only when output of a dynamic observation sound is requested in an environment which is not preset as an environment pattern. Thus, processing costs as a whole can be suppressed.

### Third Embodiment

Next, a sound field controller 300 of a third embodiment will be described. The sound field controller 300 of the third embodiment does not allow a memory 10 to previously store predetermined control sounds. At predetermined timing, it detects an environment produced when it is actually used by a user, and sequentially generates control sounds based on the detected environment.

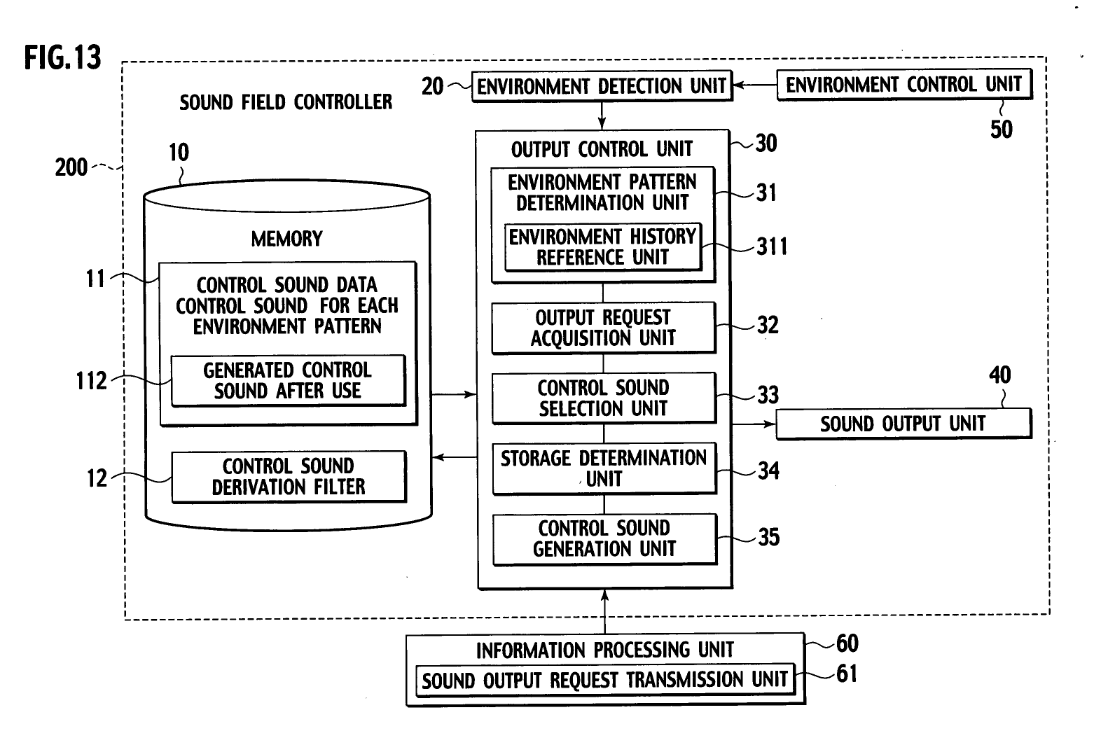

FIG. 13 is a block diagram showing a configuration of the sound field controller of the third embodiment. As shown in FIG. 13, the sound field controller of this embodiment includes the memory 10, an environment detection unit 20, an output control unit 30, a sound output unit 40, and an environment control unit 50. The configuration and operations are basically the same as those of the sound field controller 100 of the first embodiment. Here, differences between the first and third embodiments will be mainly described, and repetitive description of the common parts will be omitted.

The memory 10 of this embodiment can store control sound data 11 and a control sound derivation filter 12. However, before use of the memory, the control sound data 11 are not stored. The control sound data 11 stored in the memory 10 are generated by a control sound generation unit 35 after the user has started to use the memory. The control sound derivation filter 12 derives, based on an environment, a control sound which allows a listener to hear a predetermined observation sound at a predetermined control point, and is the same as the control sound derivation filter H(,,) described in the first embodiment.

The output control unit 30 includes a control sound generation unit 35 and a control sound storage unit 36. The control sound generation unit 35 determines whether or not it is the right timing to generate a control sound, and, when it determines that it is the right timing to generate the control sound, derives respective control sounds corresponding to one or more of observation sounds by use of the control sound derivation filter 12 based on an environment detected by the environment detection unit 20. In this embodiment, a control sound corresponding to a predetermined observation sound is generated in an environment when the user actually utilizes the sound field controller 300, and the generated control sound is used as the control sound data 11. This embodiment is different from the first embodiment in that no control sounds are stored before use by the user (before shipment of products). In the first embodiment, the control sound corresponding to the predetermined observation sound is previously created for each environment pattern.

In this embodiment, “the right timing to generate the control sound” means the timing when it is fictitiously determined that conditions for generating the control sound are completed. Although not particularly limited, “the right timing to generate the control sound” can be set to be: the timing when a predetermined environment is continued for a predetermined period of timing or more after the user has started to use the sound field controller; the timing when the user sets a predetermined environment and designates the environment as a condition for generating a control sound after he/she has started to use the sound field controller; the timing when the user utilizes the sound field controller for the first time; the timing when a predetermined period of time passes after the user has started to use the sound field controller; or the timing when the user inputs a command to generate a control sound. Although not particularly limited, it is preferable that the timing to generate the control sound is different from the timing to output the control sound. This is because a processing load is increased if generation processing and output processing are simultaneously performed. In this embodiment, after having started to use the sound field controller, the user sets a seat position, a backrest position, a headrest position, a microphone position, temperature and humidity of an automatic air conditioner, and the like in a vehicle in which a sound field is formed so as to have an optimum state for the user. Thereafter, the timing when the user inputs a command to start generation of a control sound is set as “the right timing to generate the control sound”. In this case, the control sound generated based on the environment pattern detected at the timing described above is stored in the memory 10. The command to start a control sound generation is a command to start environment detection processing and is received by the environment detection unit 20. Alternatively, the timing when a predetermined period of time passes after the user has started to use the sound field controller may be set as the timing to generate a control sound. In this case, a frequently-detected environment pattern is derived from an environment history detected between the time when the user started to use the controller and the time when a predetermined period of time passes. Thereafter, a control sound generated based on the derived environment pattern is stored in the memory 10. Further alternatively, the timing when a change in the detected environment history becomes a predetermined value or less after the user has started to use the controller may be set as “the right timing to generate the control sound”. Still further alternatively, by focusing attention on that the user tries various settings of an environment after having started to use the controller and that the set environment ends up converging on an environment suitable for the user, an environment pattern when variations in environment values within a predetermined period of time becomes a predetermined value or less is derived. Accordingly, a control sound generated based on the derived environment pattern may be stored in the memory 10.

Moreover, the control sound generation unit 35 determines whether or not the environment detected by the environment detection unit 20 is changed. In the case where the environment of the sound field is changed and where it is determined that it is the right timing to generate the control sound, the control sound generation unit 35 generates control sounds corresponding to one or more of observation sounds by use of the control sound derivation filter 12 based on a new environment and/or an environment history detected by the environment detection unit 20. Thus, in the case where there are a plurality of users of the sound field controller 300, it is possible to generate control sounds corresponding to environments different from each other depending on the users. For example, in the case where a sound field formed in a vehicle interior is controlled, it is possible to generate and store control sounds corresponding to a plurality of respective users who share a vehicle.

The control sound storage unit 36 stores in the memory the control sounds generated by the control sound generation unit 35, as the control sound data (control sound data generated after use of the controller is started) 112 in association with the environments used for the generation thereof.

The control sounds, which are generated and stored after use of the controller is started, are utilized as in the case of the control sound data 11 described in the first embodiment or the second embodiment. When acquiring a sound output request for an observation sound, the output control unit 30 selects or generates a control sound which corresponds to the observation sound requested to be outputted and also corresponds to an environment detected by the environment detection unit 20. Thereafter, the output control unit 30 allows the sound output unit 40 to output the selected or generated control sound.

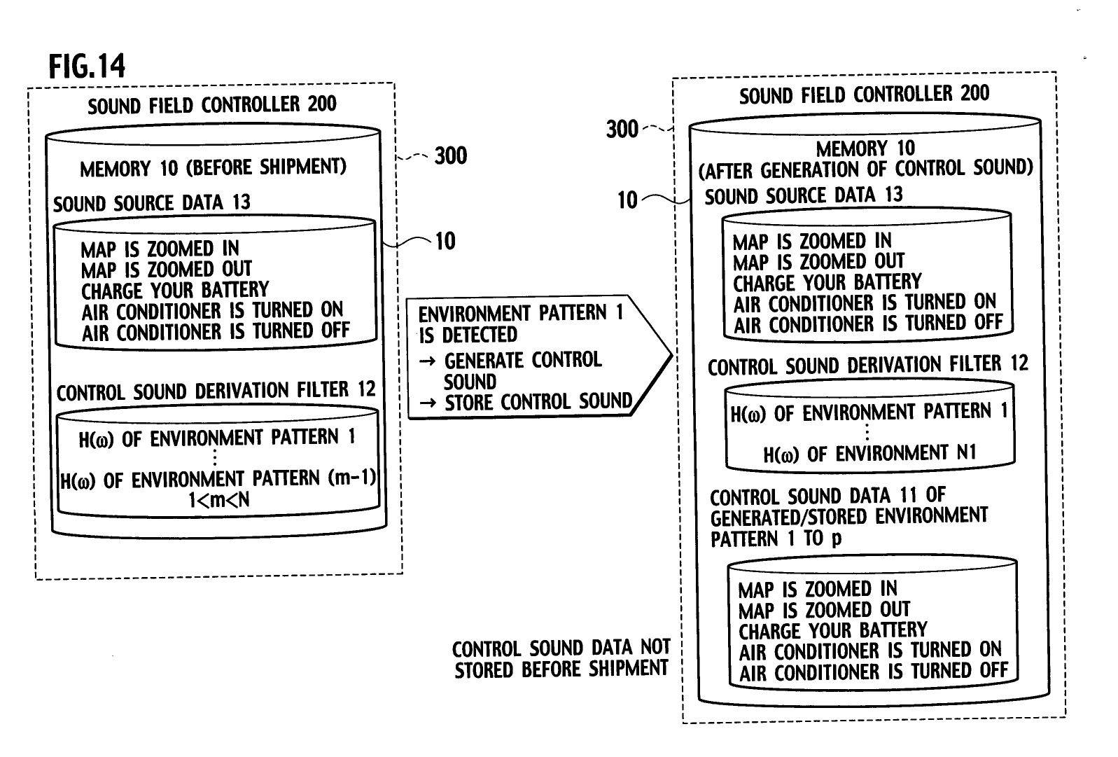

FIG. 14 is a view for explaining the memory 10 of the third embodiment. The memory 10 shown on the left side of FIG. 14 is one before shipment, and the memory 10 shown on the right side of FIG. 14 is one after use of the controller has been started. The memory 10 before shipment stores the sound source data 13 and the control sound derivation filter 12. The memory 10 (on the right side of FIG. 14) after the user has started to use the controller and control sounds are generated stores control sound data for each of environment patterns generated in addition to the sound source data 13 and the control sound derivation filter 12. The control sound data of this embodiment are generated for a plurality of actually detected environment patterns (1 to P), respectively, and stored in association with the environment patterns.

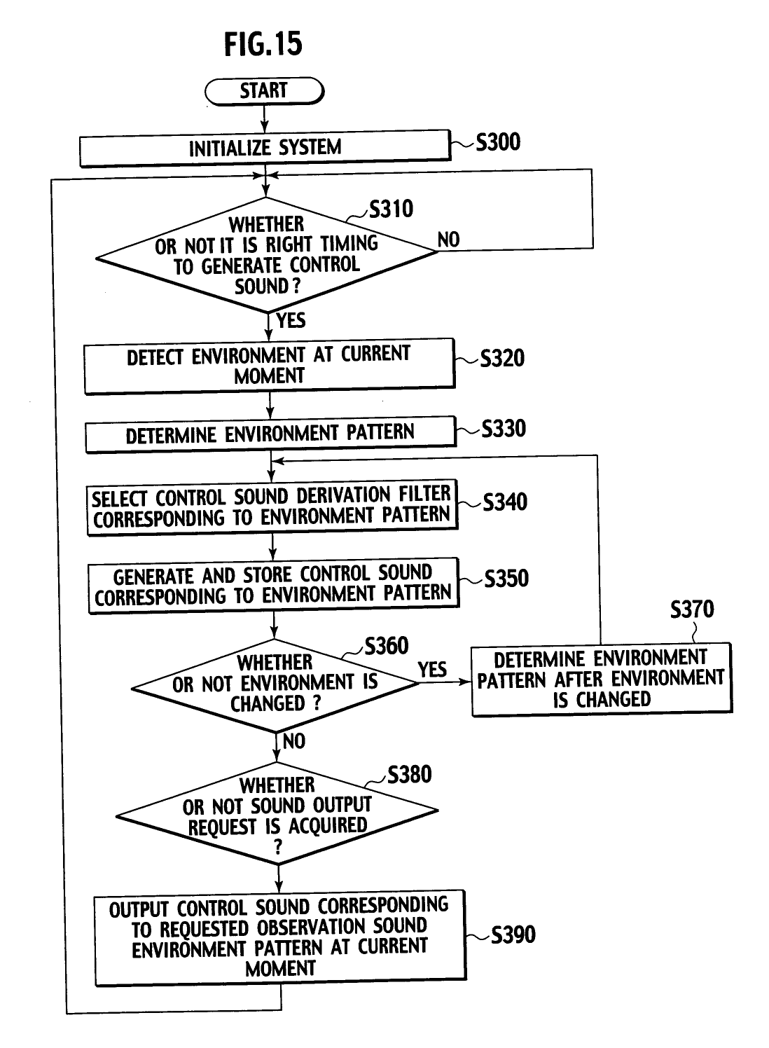

FIG. 15 is a flowchart showing a control procedure of the third embodiment. When the sound field controller 300 is started, a system is initialized (S300), and the control sound generation unit 35 determines whether or not it is the right timing to generate control sounds (S310). When it is determined that it is the right timing to generate control sounds (Y in S310), the environment detection unit 20 detects an environment at the current moment and sends out the detected environment information to the output control unit 30 (S320). The environment pattern determination unit 31 determines an environment pattern based on the obtained environment information (S330). The control sound generation unit 35 selects a control sound derivation filter 12 corresponding to the environment pattern (S340). The control sound generation unit 35 generates control sounds corresponding to the determined environment pattern by use of the selected control sound derivation filter 12. The control sounds are generated for all observation sounds expected to be heard by a listener. The control sound storage unit 36 stores the generated control sounds in the memory 10 (S350). The control sound generation unit 35 determines whether or not the environment is changed (S360), and, if the environment is changed (Y in S360), determines an environment pattern after the change (S370) and generates control sounds corresponding to a new environment pattern (S340 to S360).

After the control sounds are stored, the output request acquisition unit 32 waits for a request to output an observation sound. If the output request acquisition unit 32 acquires the output request (S380), the control sound selection unit 33 allows the sound output unit 40 to output a control sound which corresponds to the observation sound requested to be outputted and also corresponds to an environment pattern based on an environment observed at the current moment from the already stored control sound data (S390).

According to this embodiment, control sounds are generated based on an environment set by a user who actually utilizes the sound field controller 300, and appropriate control sounds can be outputted. Particularly in the case where a sound field is formed in a vehicle interior, a seat position, an angle of a backrest, a headrest position and the like, which are included in an environment of the sound field, depend on physical characteristics and preferences of the user. Moreover, the environment of the sound field in the vehicle interior differs by each individual. Thus, if the control sounds can be generated based on the environment actually set by the user, predetermined sound field control can be accurately executed. Since the control sounds are generated at timing suitable for generation of the control sounds in this embodiment, the predetermined sound field control can be accurately executed. Further, if generation of control sounds and output of control sounds are not simultaneously performed, the control sounds are not generated at timing when output of observation sounds is requested. Thus, it is not required to provide a high-speed arithmetic unit for simultaneously performing generation and output. Consequently, there is no need to prolong time required to output the observation sounds after the request to output them. Specifically, in this embodiment, timing to generate control sounds is determined, and the control sounds are generated at the timing. Thus, there is no risk of affecting output processing of the observation sounds. Moreover, there is no need to store control sounds generated for each of previously assumed environment patterns. Thus, manufacturing costs can be reduced.

### Fourth Embodiment

Next, a sound field controller 400 of a fourth embodiment will be described. The sound field controller 400 of the fourth embodiment includes a control sound output monitoring unit 37 in an output control unit 30. The sound field controller 400 is characterized in that: when a control sound is outputted, which is controlled so as to set an observation sound at an aural null to be silent, output of the control sound is stopped in a case where a sound pressure of the observation sound at the aural null is increased compared to that before the control sound is outputted. The function described above can be applied to the sound field controllers of the first to third embodiments.

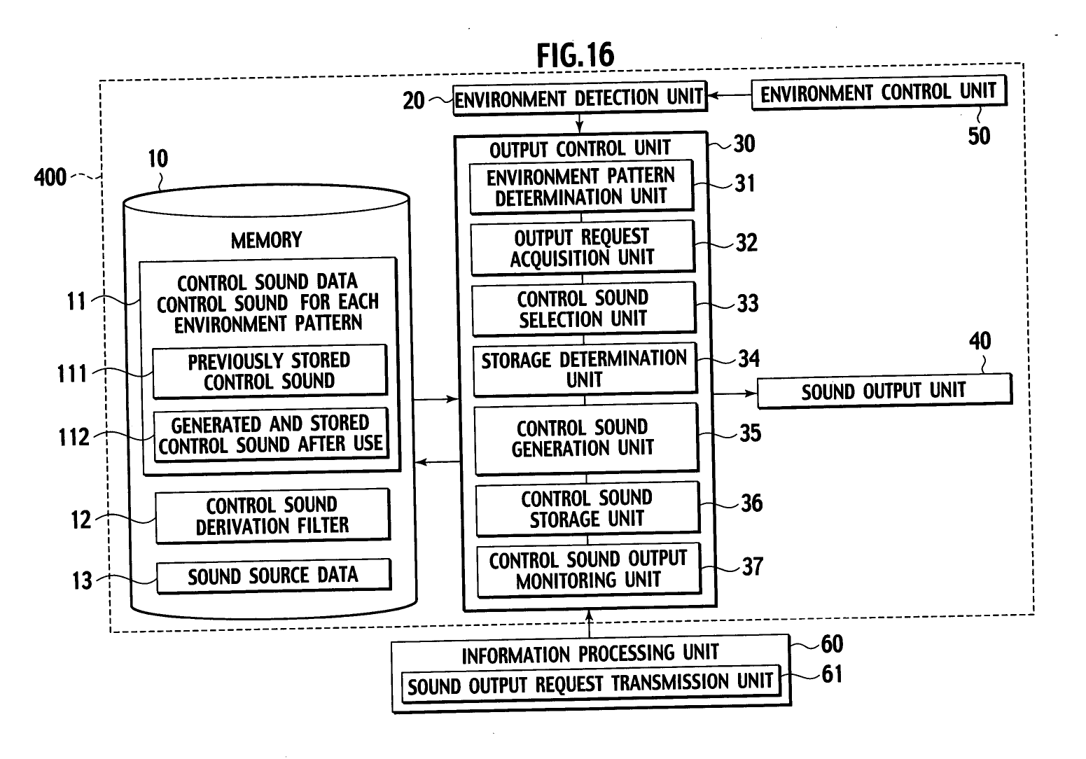

FIG. 16 is a block diagram showing a configuration of the sound field controller of the fourth embodiment. As shown in FIG. 16, the sound field controller of this embodiment includes a memory 10, an environment detection unit 20, the output control unit 30, a sound output unit 40, and an environment control unit 50. The configuration and operations are basically the same as those of the sound field controller 100 of the first embodiment. Here, differences between the first and second embodiments will be mainly described, and repetitive description of the common parts will be omitted.

The output control unit 30 of this embodiment includes the control sound output monitoring unit 37. When a control sound is outputted which is controlled so as to set an observation sound at a preset aural null to be silent, the control sound output monitoring unit 37 acquires a sound pressure of the observation sound at the aural null. The sound pressure is acquired by use of a sound collector. In this embodiment, the aural null is set in the vicinity of a microphone, and the sound pressure at the aural null is acquired by use of the microphone. The control sound output monitoring unit 37 uses the microphone to acquire sound pressures at the aural null before and after the control sound is outputted. If the acquired sound pressure is larger than the sound pressure before the control sound is outputted, output of the control sound controlled so as to set the observation sound at the aural null to be silent is stopped. Specifically, if a sound pressure of the control sound outputted so as to set the observation sound to be silent is increased, it is determined that the sound field control has failed, so that the output of the control sound is stopped.

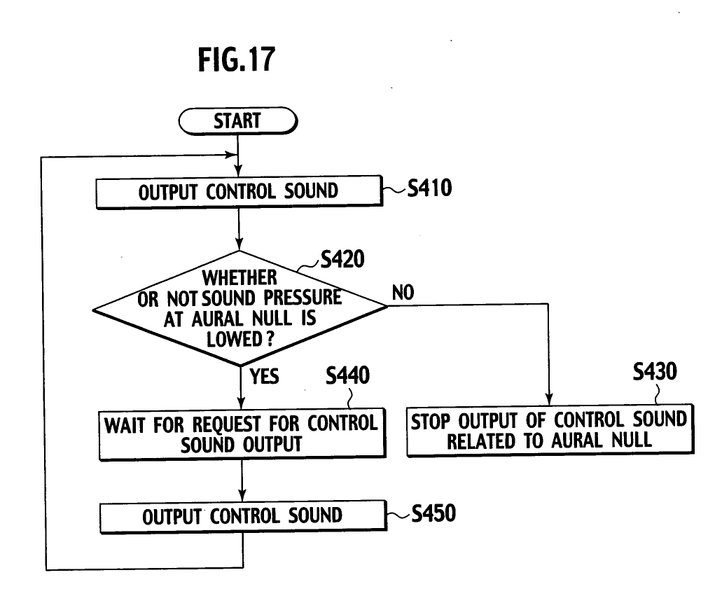

FIG. 17 is a flowchart showing a control procedure of the fourth embodiment. As shown in FIG. 17, when the sound output unit 40 outputs a control sound (S410), the control sound output monitoring unit 37 determines whether or not a sound pressure at an aural null is lowered compared with a sound pressure before the control sound is outputted (S420). If the sound pressure at the aural null is lowered compared with that before the control sound is outputted (Y in S420), it is determined that the sound field control has been properly processed. Accordingly, a sound output request for a predetermined observation sound is waited for (S440), and output of the control sound is continued (S450). If the control sound output monitoring unit 37 determines that the sound pressure at the aural null is larger than a sound pressure before the control sound is outputted (N in S420), the control sound output monitoring unit 37 stops output of the control sound controlled so as to set the observation sound at the aural null to be silent (S430). The stopping of output may be canceled after a predetermined period of time passes or when the detected environment is changed.

Even when the control sound controlled so as to set the observation sound at the aural null to be silent is outputted, the observation sound at the aural null may occasionally become a sound with a larger sound pressure due to a sudden change in the environment of the sound field. For example, in a case where a user has moved a microphone, which should be controlled as an aural null, to be in a position close to a listening point, it is impossible to lower a sound pressure in the vicinity of the microphone however being set as the aural null. When control of the sound field fails, an echo sound or a large interference sound may be generated. In this embodiment, if the sound pressure at the aural null becomes larger than a sound pressure before the control sound is outputted, output of the control sound is stopped after it is determined that the sound field control has failed and. Thus, it is possible to prevent failure of the sound field control.

Although not particularly limited, in a case where control points are previously grouped on the basis of a position of a listener who hears a predetermined observation sound, and control is executed for stopping output of a control sound at a certain control point, it is preferable to stop output of a control sound at another control point belonging to the same group as the control sound. Normally, the control points are set on the basis of the listener. For example, positions of both ears of a driver who is the listener are set as listening points, and positions of both ears of a passenger that is the listener are set as aural nulls. In this embodiment, control points set based on a certain listener are grouped, and control of stopping a control sound when sound field control fails is performed by each group. Specifically, in a case where a sound pressure is increased between before and after output of a control sound for one aural null of grouped aural nulls, output of the control sound is stopped for not only the aural null at which an increase in the sound pressure is detected but also the other aural nulls belonging to the same group as the aural null described above. For example, when a sound field has been formed in a vehicle interior and two points has been set as listening points at both ears of a listener sitting in a passenger seat, it is assumed that a microphone is brought close to any one of the two listening points and that control at an aural null set on the basis of the microphone therefore fails. In such a case, output of a control sound is stopped for not only the aural null but also for the two listening points, regardless of distances from the aural null (the microphone position). If control of the aural null happened to fail, a cause of the failure is considered to be a change in the environment of the sound field including positions of the control points. The environment of the sound field is defined by positions relative to the listener. Thus, it is highly likely that sound field control cannot be properly performed for other aural nulls relative to one listener. By grouping aural nulls defined on the basis of the listener for the purpose of integrating control processing, control of preventing a disruption of the sound field can be efficiently executed in the case where sound field control happened to fail.

The entire contents of Japanese patent application P2004-225536 filed Aug. 2, 2004 are hereby incorporated by reference.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A sound field controller comprising:
a memory configured to store, for each predetermined environment, control sounds designed to form a predetermined observation sound at control points having any one of at least one preset listening point and at least one aural null;
an environment detection unit configured to detect an environment of a sound field including the control points;
an output control unit configured to select a control sound among the control sounds stored in the memory upon receiving a sound output request requesting the predetermined observation sound, said selected control sound corresponding to an observation sound requested to be outputted by the sound output request and corresponding to the environment detected by the environment detection unit; and
a sound output unit configured to output the selected control sound to the sound field.

2. The sound field controller as claimed in claim 1, wherein
the memory further stores a control sound derivation filter which derives, based on the environment, a control sound forming a predetermined observation sound at the control points,
upon receiving a sound output request requesting a predetermined observation sound, the output control unit determines whether or not a control sound corresponding to the observation sound requested to be outputted and corresponding to the environment detected by the environment detection unit is stored in the memory,
when the control sound is stored in the memory, the output control unit selects the control sound from control sounds stored in the memory, and when the control sound is not stored in the memory, the output control unit derives a control sound corresponding to the observation sound requested to be outputted by use of the control sound derivation filter based on the environment detected by the environment detection unit, and
the sound output unit outputs any one of the selected control sound and the derived control sound to the sound field.

3. The sound field controller as claimed in claim 1, wherein the environment detection unit detects, as environmental factors forming the environment of the sound field, at least any one of: a position of a listener, a direction of the listener's head, a seat position of the listener, a position of a headrest used by the listener, a temperature of the sound field, humidity of the sound field, and a position of a microphone.

4. The sound field controller as claimed in claim 1, further comprising:
an environment control unit configured to control variations in environmental factors forming the environment as to keep the environment unchanged until a control sound corresponding to the detected environment is outputted after the environment detection unit detects the environment.

5. The sound field controller as claimed in claim 4, wherein the environment control unit includes at least any one of: a position fixation unit which prevents a change in a position of a listener who listens to the observation sound; a head direction guidance unit which guides a direction of a head of the listener who hears the observation sound into a predetermined direction; an air conditioner which controls at least one of temperature and humidity of the sound field; and a microphone stand unit which fixes a position and a direction of a microphone.

6. The sound field controller as claimed in claim 1, wherein
the environment detection unit stores a history of environments detected, and
upon receiving a sound output request requesting a predetermined observation sound, the output control unit selects, from the control sounds stored in the memory, a control sound corresponding to the observation sound requested to be outputted by the sound output request and corresponding to a frequently-detected environment extracted by referring to the history of the environments detected by the environment detection unit, and
the sound output unit outputs the selected control sound to the sound field.

7. The sound field controller as claimed in claim 1, wherein, when a control sound controlled to set the observation sound at the preset aural null to be silent is outputted, the output control unit acquires a sound pressure of an observation sound at the aural null and stops output of the control sound controlled to set the observation sound at the aural null to be silent if the acquired sound pressure is larger than a sound pressure of the observation sound at the aural null before the control sound is outputted.

8. The sound field controller as claimed in claim 7, wherein the output control unit previously groups the control points on the basis of a position of a listener hearing the observation sound, and in the case of stopping output of the control sound, stops output of the control sound at another control point belonging to the same group as an aural null at which output of the control sound is stopped.

9. The sound field controller as claimed in claim 1, wherein the memory is a rewritable storage medium.

10. A sound field controller comprising:
a memory configured to store a control sound derivation filter which derives, based on an environment, a control sound forming a predetermined observation sound at control points having any one of at least one preset listening point or at least one aural null;
an environment detection unit configured to detect an environment of a sound field including the control points;
an output control unit configured to determine whether or not it is the right timing to generate a control sound, derive each control sound corresponding to at least one observation sound by use of the control sound derivation filter based on the environment detected by the environment detection unit if it is determined that it is the right timing to generate the control sound, and store the derived control sound in the memory, the output control unit configured to select, upon receiving a sound output request requesting the predetermined observation sound, a control sound corresponding to the observation sound requested to be outputted by the sound output request and corresponding to the environment detected by the environment detection unit, from the control sounds stored in the memory; and
a sound output unit configured to output the selected control sound to the sound field.

11. The sound field controller as claimed in claim 10, wherein the output control unit determines whether the environment of the sound field is changed, derives each control sound corresponding to one or more of observation sounds by use of the control sound derivation filter based on at least one of a new environment and an environment history detected by the environment detection unit if the environment of the sound field is changed and if it is determined that it is the right timing to generate the control sound, and stores the derived control sound in the memory.

12. The sound field controller as claimed in claim 10, wherein the environment detection unit detects, as environmental factors forming the environment of the sound field, at least any one of: a position of a listener, a direction of the listener's head, a seat position of the listener, a position of a headrest used by the listener, a temperature of the sound field, humidity of the sound field, and a position of a microphone.

13. The sound field controller as claimed in claim 10, further comprising:
an environment control unit configured to control variations in environmental factors forming the environment as to keep the environment unchanged until a control sound corresponding to the detected environment is outputted after the environment detection unit detects the environment.

14. The sound field controller as claimed in claim 13, wherein the environment control unit includes at least any one of: a position fixation unit which prevents a change in a position of a listener who listens to the observation sound; a head direction guidance unit which guides a direction of a head of the listener who hears the observation sound into a predetermined direction; an air conditioner which controls at least one of temperature and humidity of the sound field; and a microphone stand unit which fixes a position and a direction of a microphone.

15. The sound field controller as claimed in claim 10, wherein
the environment detection unit stores a history of environments detected, and
upon receiving a sound output request requesting a predetermined observation sound, the output control unit selects, from the control sounds stored in the memory, a control sound corresponding to the observation sound requested to be outputted by the sound output request and corresponding to a frequently-detected environment extracted by referring to the history of the environments detected by the environment detection unit, and
the sound output unit outputs the selected control sound to the sound field.

16. The sound field controller as claimed in claim 10, wherein, when a control sound controlled to set the observation sound at the preset aural null to be silent is outputted, the output control unit acquires a sound pressure of an observation sound at the aural null and stops output of the control sound controlled to set the observation sound at the aural null to be silent if the acquired sound pressure is larger than a sound pressure of the observation sound at the aural null before the control sound is outputted.

17. The sound field controller as claimed in claim 16, wherein the output control unit previously groups the control points on the basis of a position of a listener hearing the observation sound, and in the case of stopping output of the control sound, stops output of the control sound at another control point belonging to the same group as an aural null at which output of the control sound is stopped.

18. The sound field controller as claimed in claim 10, wherein the memory is a rewritable storage medium.

19. A sound field controller comprising:
a memory means for storing, for each predetermined environment, control sounds designed to form a predetermined observation sound at control points having any one of at least one preset listening point and at least one aural null;
an environment detection means for detecting an environment of a sound field including the control points;
an output control means for selecting a control sound among the control sounds stored in the memory upon receiving a sound output request requesting the predetermined observation sound, said selected control sound corresponding to an observation sound requested to be outputted by the sound output request and corresponding to the environment detected by the environment detection unit; and
a sound output means for outputting the selected control sound to the sound field.

20. A method for controlling sound field, comprising:
storing, for each predetermined environment, control sounds designed to form a predetermined observation sound at control points having any one of at least one preset listening point and at least one aural null;
detecting an environment of a sound field including the control points;
selecting a control sound among the control sounds upon receiving a sound output request requesting the predetermined observation sound, said selected control sound corresponding to an observation sound requested to be outputted by the sound output request and corresponding to the environment detected; and
outputting the selected control sound to the sound field.

21. The method as claimed in claim 20, further comprising:
storing a control sound derivation filter which derives, based on the environment, a control sound forming a predetermined observation sound at the control points;
determining, upon receiving a sound output request requesting a predetermined observation sound, whether or not a control sound corresponding to the observation sound requested to be outputted and corresponding to the environment detected by the environment detection unit is stored in the memory,
deriving, when the control sound is not stored, a control sound corresponding to the observation sound requested to be outputted by use of the control sound derivation filter based on the environment detected.

22. A sound field controller comprising:
storing a control sound derivation filter which derives, based on an environment, a control sound forming a predetermined observation sound at control points having any one of at least one preset listening point or at least one aural null;
detecting an environment of a sound field including the control points;
determining whether or not it is the right timing to generate a control sound;
deriving each control sound corresponding to at least one observation sound by use of the control sound derivation filter based on the environment detected if it is determined that it is the right timing to generate the control sound;
storing the derived control sound;
selecting a control sound among the control sounds stored, upon receiving a sound output request requesting the predetermined observation sound, said control sound corresponding to the observation sound requested to be outputted by the sound output request and corresponding to the environment detected, from the control sounds stored; and
outputting the selected control sound to the sound field.
